(19) United States
(12) Patent Application Publication
(10) Pub. No.: US 2025/0331067 A1
(43) Pub. Date: Oct. 23, 2025

(54) SYSTEMS, DEVICES, AND METHODS FOR A HEATED STORAGE BOX

(71) Applicant: Battalion Tools Inc., Mississauga (CA)

(72) Inventor: Bradley William Cleaver, Mississauga (CA)

(73) Assignee: Battalion Tools Inc., Mississauga (CA)

(21) Appl. No.: 18/967,996

(22) Filed: Dec. 4, 2024

Related U.S. Application Data
(60) Provisional application No. 63/605,712, filed on Dec. 4, 2023.
(60) Provisional application No. 63/665,158, filed on Jun. 27, 2024.

(51) Int. Cl. H05B 1/02

(52) U.S. Cl. CPC H05B 1/0275

(57) ABSTRACT

A heating box for keeping tools heated while stored within the box is provided. The heating box includes a heater configured to heat an interior of the heating box, a lock configured to lock and unlock a lid of the heating box, and a user interface configured with heating, connectivity, and locking controls.

### FIELD

The present disclosure generally relates to storage units, and, in particular, to systems, devices, and methods for portable storage units.

### BACKGROUND

Items such as tools, batteries, and other materials such as silicones, paints or liquids may be transported through cold climates or other temperatures that are not suitable for the optimal storage of the items.

### SUMMARY

In accordance with an aspect, there is provided a heating box, including: a heater configured to heat an interior of the heating box; a lock configured to lock and unlock a lid of the heating box; and a user interface configured with heating, connectivity, and locking controls.

In some embodiments, a power supply or battery is connected to the heater.

In some embodiments, the heating control is configured to configure a temperature of the interior of the heating box using the heater.

In some embodiments, the connectivity control is configured to enable pairing with a device using Bluetooth.

In some embodiments, the locking control is configured to lock and unlock the lock.

In accordance with an aspect, there is provided a computer-implemented method for configuring a heating box, the method including: pairing a device with the heating box using a software application; configuring a light of heating box in ON or AUTO mode using the device; configuring a temperature display of the heating box in Celsius or Fahrenheit using the device; configuring a password for locking or unlocking the heating box; and configuring a clock display of the heating box.

Other aspects and features and combinations thereof concerning embodiments described herein will become apparent to those ordinarily skilled in the art upon review of the instant disclosure of embodiments in conjunction with the accompanying figures.

### DESCRIPTION OF THE DRAWINGS

In the figures, embodiments are illustrated by way of example. It is to be expressly understood that the description and figures are only for the purpose of illustration and as an aid to understanding. Embodiments will now be described, by way of example only, with reference to the attached figures, wherein in the figures:

FIG. 1 depicts a front view of a heating box, according to some embodiments;

FIG. 2 depicts a front perspective view of a heating box, according to some embodiments;

FIG. 3 depicts a side view of a heating box, according to some embodiments;

FIG. 4 depicts a rear perspective view of a heating box, according to some embodiments;

FIG. 5 depicts a perspective view of an open heating box, according to some embodiments;

FIG. 6 depicts a focused perspective view of the interior of a heating box, according to some embodiments;

FIG. 7 depicts a perspective view of an open heating box, according to some embodiments;

FIG. 8 depicts a focused view of an interior of an open heating box, according to some embodiments;

FIG. 9 depicts a focused view of the interior front wall of a heating box, according to some embodiments;

FIG. 10 depicts a rear perspective view of a heating box, according to some embodiments;

FIG. 11 depicts a rear perspective view of a heating box, according to some embodiments; and

FIG. 12 depicts a focused view of a handle of a heating box, according to some embodiments.

FIG. 13 depicts a user interface panel design according to an embodiment of the invention.

### DETAILED DESCRIPTION

Embodiments described herein provide a heated storage box device and system that can be used to keep items, such as tools, batteries, and other materials such as silicones, paints or liquids, warm. The box can keep the items warm and prevent them from freezing in cold climates and, additionally, keep the items secure. In cold climates, power tools and batteries tend not to charge or function optimally, and silicones, paints, and liquids are susceptible to freezing.

As used herein, box 100 can be referred to as storage box or heating box.

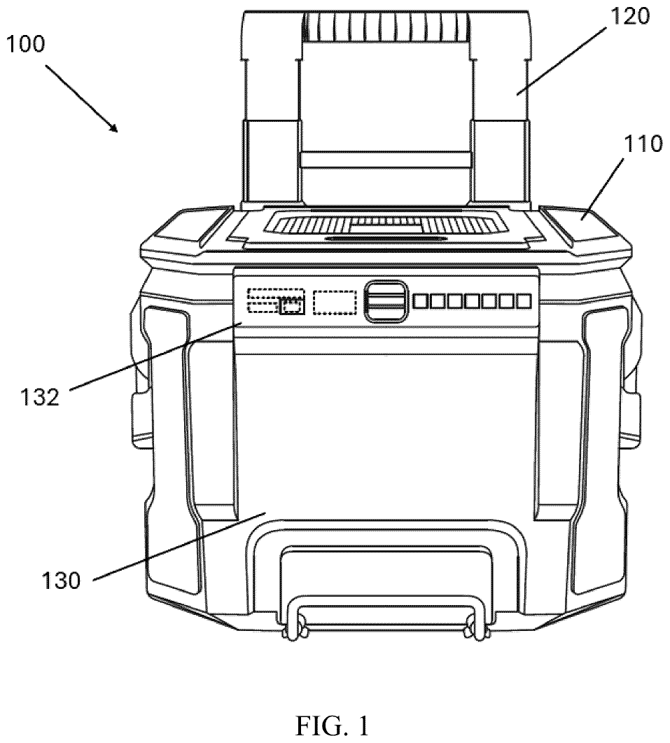

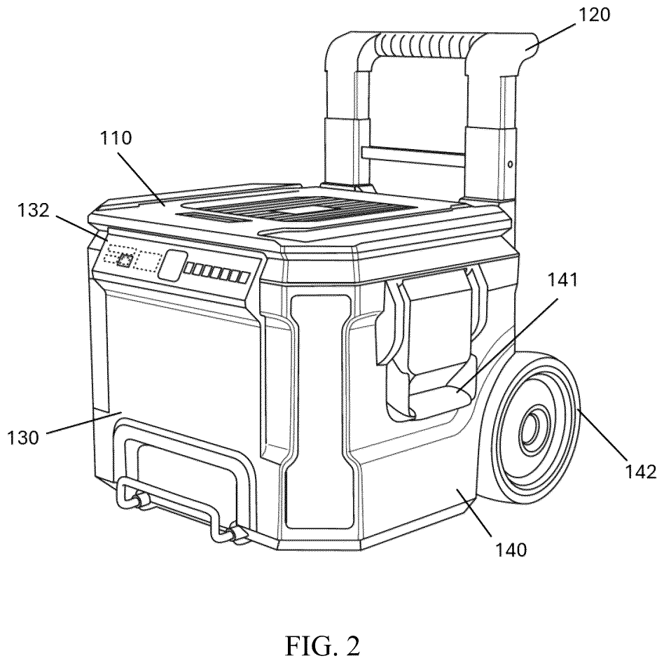

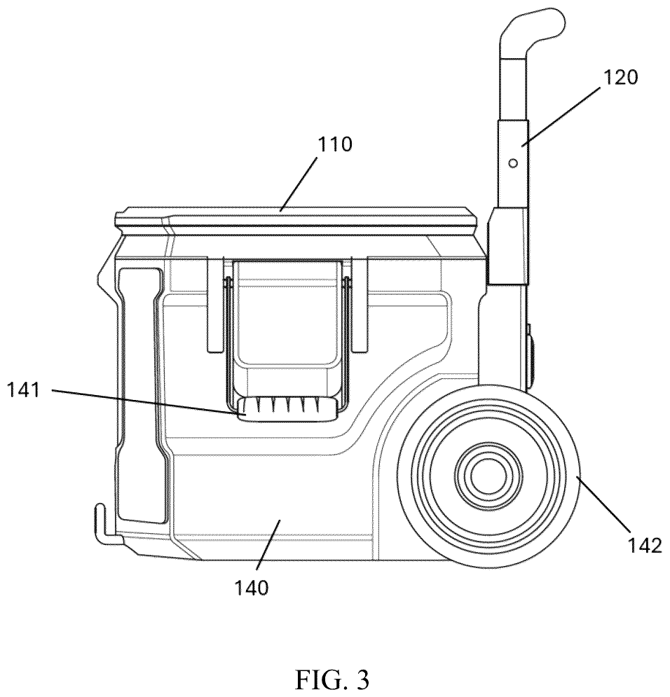

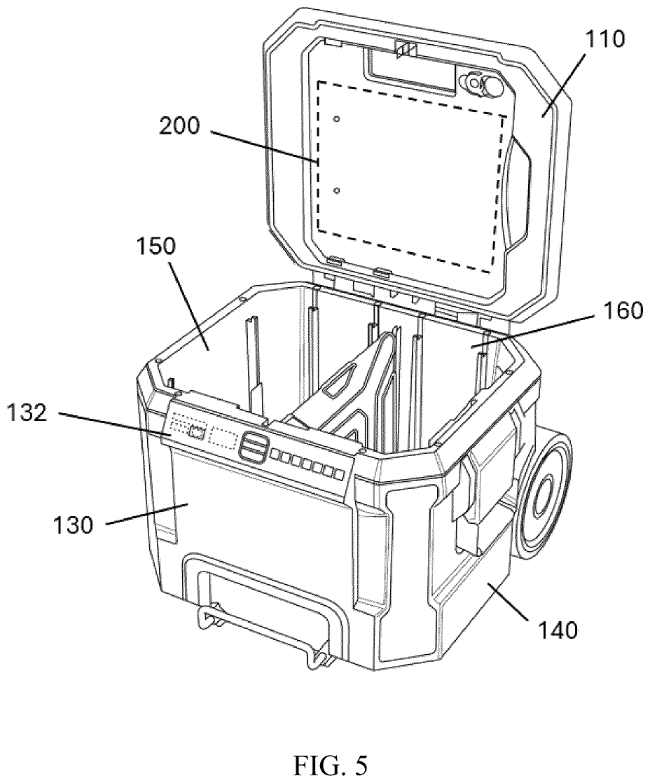

As shown in FIGS. 1-5 a heating box 100, according to some embodiments, includes a front wall 130, a rear wall 160, and two side walls 140, 150. Heating box 100 also includes a lid 110 to seal the interior space within the heating box 100. Box 100 can be easily mobilized and fit in an average-sized automobile. Box 100 has a built-in locking system, such as a digital or combination locking system, and accordingly, does not require users to utilize a separate locking device (i.e., a padlock). Box 100 has a heating function. Box 100 is configured with two or at least two wheels on the bottom. Box 100 is configured with a telescoping handle that can help enable improved mobility. Box 100 is configured with a receptacle and USB port(s) on the inside that can allow a user to charge or plug-in equipment. Box 100 is configured with a chargeable battery pack inside. Box 100 is configured with built-in heaters on the inside, and a user interface 132 on the outside.

The front wall 130, rear wall 160, and two side walls 140, 150 of the heating box 100 have heating elements (not shown) within the respective walls 130, 140, 150, and 160. Box 100 also includes an interface panel 132 positioned on the front wall 130 with buttons or a touchscreen configured to control the heating elements within the walls 130, 140, 150, and 160.

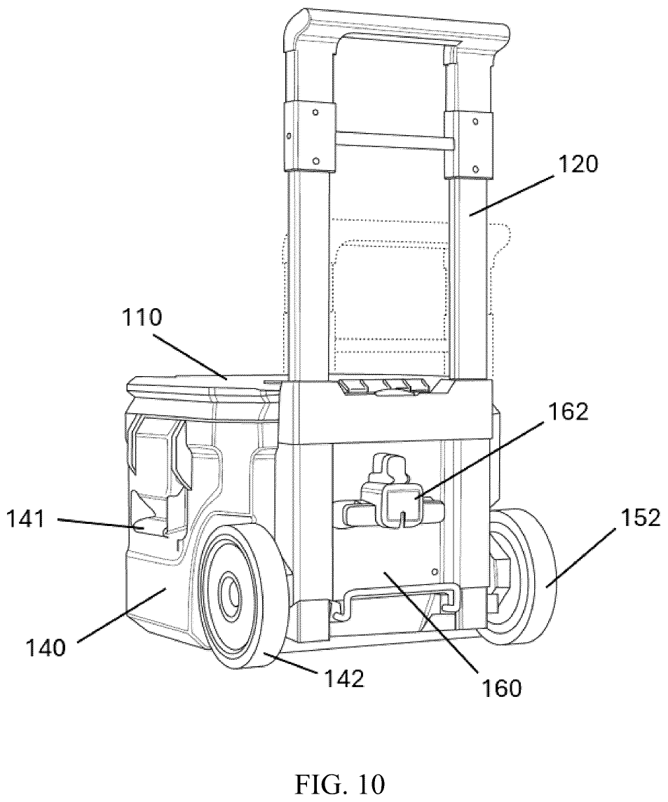

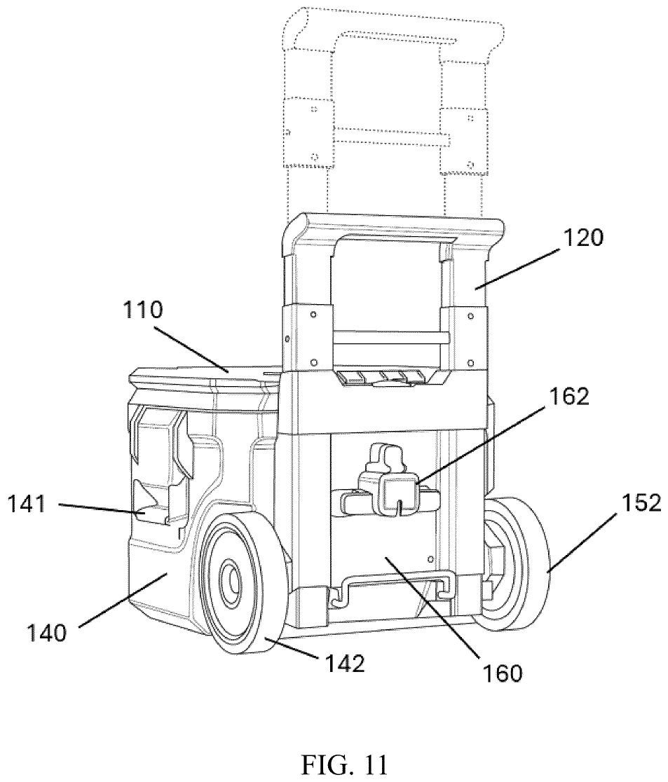

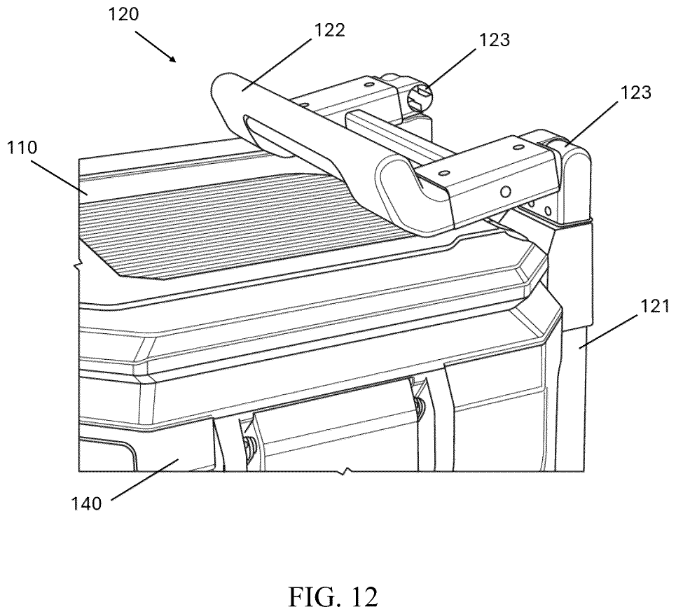

A telescoping and folding handle 120 is attached to the rear wall 160 of the box 100. Specifically, as shown in FIG. 12, the handle 120 may have a telescoping ability by extending upwards from the sleeves 121 on the rear wall 160 of the box 100. Hinges 123 allow for the hand-held portion 122 of the handle 120 to fold in a forward direction to minimize the spatial footprint of the box 100 for storage. In addition, as shown in FIGS. 1-5, 10, and 11, the box 100 further includes handles 141, 151 to facilitate carried transport of the box 100 and wheels 142, 152 to facilitate towed transport of the box 100.

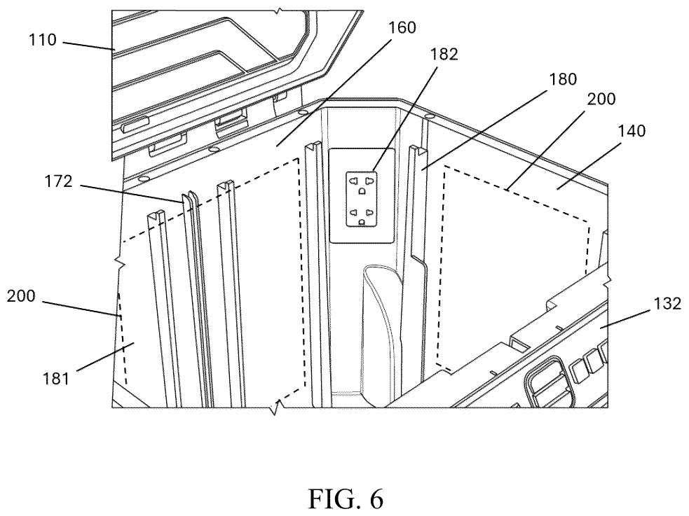

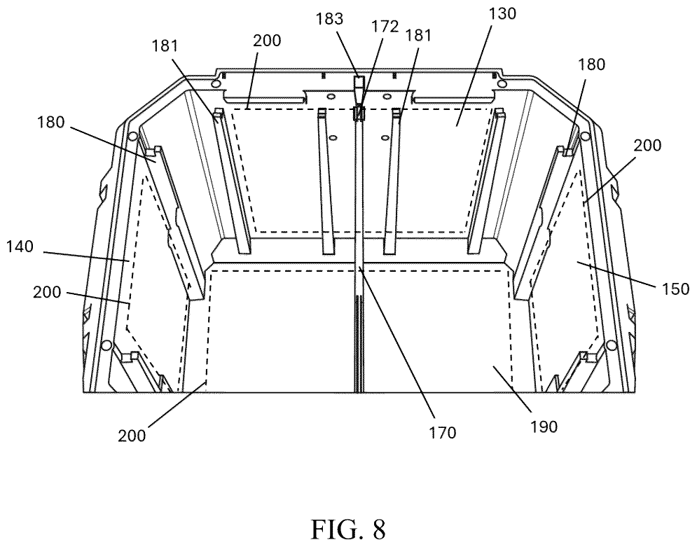

FIG. 6 shows an example plug 182 inside box 100, according to some embodiments. The plug 182 is configured to connect with a power source (not shown) of box 100 and allow charging of an item stored inside box 100. The power source (not shown) may be a battery stored internally within the respective walls 130, 140, 150, and 160, within the lid 110, or within the base 190 (shown in FIG. 8).

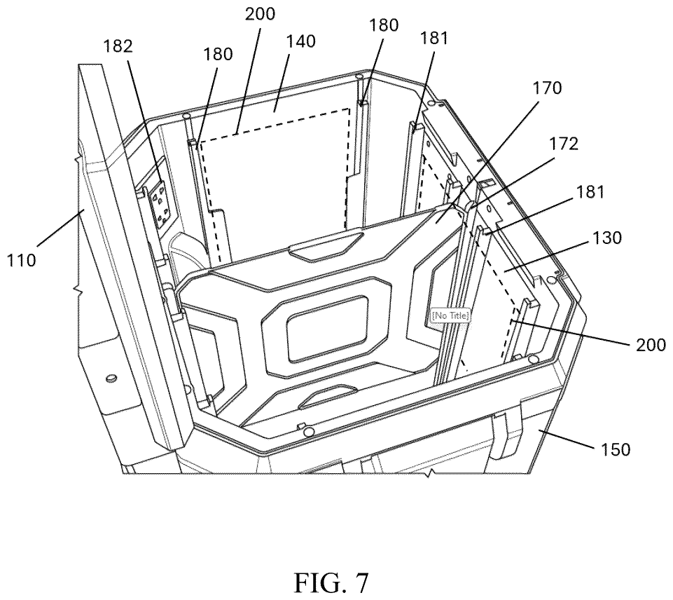

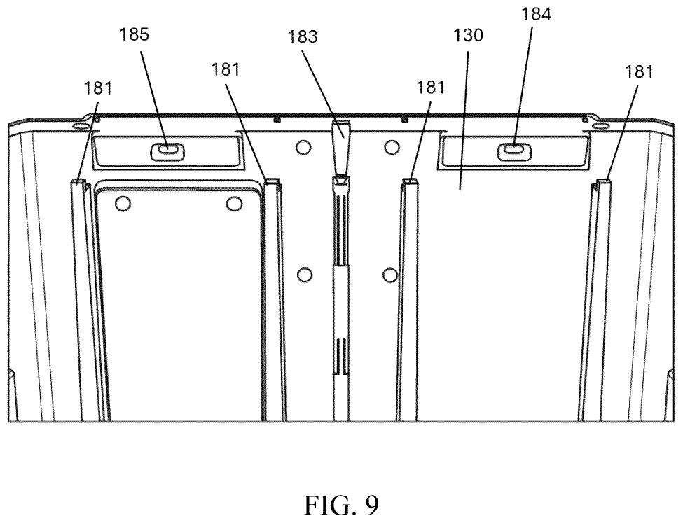

As shown in FIGS. 7-9, the interior of the box 100 may further include internal features such as a divider 170, which removable and slides into grooves 172 to remain in position. Other features such as internal structures 180, 181 may be used to support other attachments and accessories that are compatible with the box 100. With respect to FIG. 9, the front wall 130 includes the lock 182 on the interior side thereof. The front wall 130 also includes USB ports 184, 185 for charging devices that may be stored within the box 100.

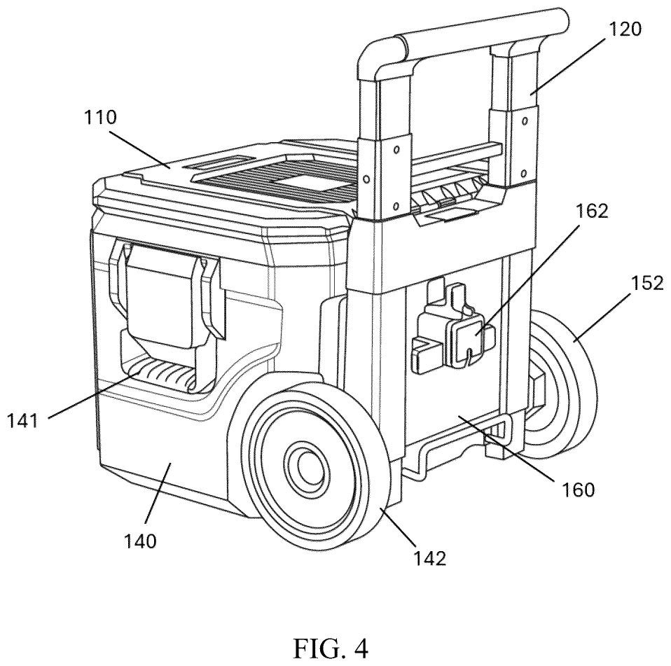

As shown in FIG. 4, shows an example wire-wrap component 162 positioned at an exterior surface of box 100 that allows for a wire, a cable, or similar item, to be retained at the box 100 by wrapping the wire or item around the wire-wrap component 162. In some embodiments, one or more of these features are omitted from box 100.

The box 100 is configured with at least one heater 200 inside box 100, which connects with a socket (e.g., 120V AC), and which sources power via a cable (e.g., an 120V AC). The plug 182 draws power from a power supply. The internal plug 182 and any USB port(s) (not shown) that may be included within the box 100 are functional only when the box 100 is connected to a power source. A main printed circuit board assembly (PCBA) (not shown) draws power from a battery (not shown), and the PCBA is configured to configure and interoperate with one or more USB ports, such as USB-C 184 and USB-A 185, each configured with a LED light. The PCBA is configured to configure a display (e.g., user interface) of box 100. PCBA is configured to configure an electronically controlled lock 183 of box 100. In some embodiments, box 100 has the following certifications: EMC, FCC, CE, IC, BQB. In some embodiments, box 100 is configured with a minimum of Bluetooth version 5.0.

The box 100 is configured with one or more of each of: an AC outlet 182, a power supply (not shown), a heater 200, a PCBA (not shown), a user interface panel 132, lock 183, USB port 184, 185, light (not shown), and battery (not shown). In some embodiments, a control knob or other user interface element can be used and/or substituted for the user interface 132. For example, if a control knob is used, fast rotary movements will increase the values faster.

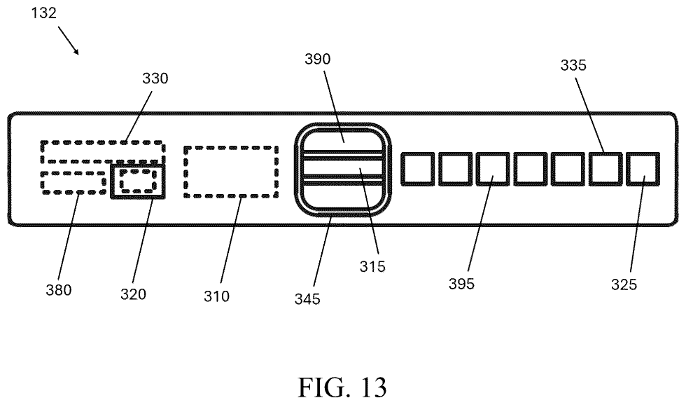

The user interface 132, as shown in FIGS. 1, 2, and 13, can include a push button security system and a digital touchscreen displaying features such as: set temperature inside box;

actual temperature inside box; box locked; box unlocked; Bluetooth connectivity; plugged in; battery life; and current time. The temperature set by the user interface panel 132 can increase with 5-degree Celsius steps for example. Celsius to Fahrenheit setting can also be configured in a software application (e.g., mobile app).

As used herein, an icon can be referred to as a display.

Icon 320 shows the actual temperature inside the box 100. The internal temperature is measured by an internal temperature sensor. The first digit will be a negative sign (−) if the temperature is lower than 0 degrees. If it is above 0, then it will be blank.

Icon 330 shows the lock/unlock status of box 100.

Icon 340 shows the heating ON/OFF status. When it is ON, the icon will appear. When it is OFF, the icon will disappear.

Icon 350 shows the Bluetooth status. If it is blinking, it is in PAIR mode. When Bluetooth is connected the Bluetooth icon is always ON. Long pressing (e.g., 3 s) the Bluetooth button 325 on the keypad 395 will activate the Bluetooth and go into pairing mode. The LED circle around will blink blue, and once the Bluetooth connection is established, LED circle will light continuous blue, according to some embodiments. To disconnect the existing Bluetooth connection, long pressing (e.g., 3 s) the Bluetooth button 325 on the keypad 395 will cause it to disconnect the existing connection and go to pairing mode. The LED circle around will blink blue. Very long pressing (e.g., 10 s) the Bluetooth button 325 on the keypad 395 will turn off the Bluetooth.

Icon 360 shows if the external power plug is plugged in or not.

Icon 370 shows the battery icon. When the battery is charging, the battery icon in icon section 330 will flash in white. When the battery is charged full, it will light continuously.

This signals the user that the AC cable can be removed. When the battery is 20% it will flash in red colour. At other times, the battery icon will not light.

Icon 380 shows a real time clock. The clock information is received from communication from the software application (e.g., mobile app).

Icon 390 shows the on/off button and heating button. To turn on the box 100, the HEAT button 315 is pressed for a period of time (e.g., 5 seconds). To turn off, the HEAT button 315 is pressed for a period of time (e.g., 3 seconds). To turn on/off the heating function, the temperature button 315 in the middle is pressed, according to some embodiments. Once the heating function is enabled, the up or bottom arrows can be pressed to adjust the required temperature setting. The temperature will increase or decrease in steps (e.g., with 5 degree Celsius steps). In some embodiments, to turn on/off the heating function, the AC power cable is plugged in. Then, temperature button 315 is pressed. Once the heating function is enabled, the up or bottom arrows at 390 is used to adjust the required temperature setting. The set temperature values list is as follows: 5, 10, 15, . . . , 30 degrees Celsius (and their negative values) or 41 degrees Fahrenheit to 86 degrees Fahrenheit.

Light ring 345 around temperature controls at 390 is configured to display light as follows. Green continuous: Default mode when the display is light on. Red blink: The password entered is incorrect. Green blink: The password entered is correct. Blue blink: Bluetooth pair mode is engaged. Blue continuous: Bluetooth is connected. In some embodiments, other light colour(s) are used.

The keypad 395 can be used to input the password to unlock the box. As an example, if the password is ‘1255’ then the user will press ‘1/2’, ‘1/2’, ‘5/6’, ‘5/6’ in order. If the password is ‘1491’, the customer will press ‘1/2’, ‘3/4’, ‘9/0’, ‘1/2’ in order. The factory default password is ‘0000’. The user can change the password through the software application (e.g., Bluetooth app). Other keypad configurations are possible in various embodiments. A lock button 335 at the keypad 395, when pressed, is configured to lock box 100 when it is in unlocked state. When box 100 is in locked state, when the lock button 335 is pressed, box 100 is unlocked.

In some embodiments, box 100 is configured with a light (e.g., LED light) (not shown) inside the box which is on when the box lid 110 is open and off when the lid 110 is closed. Box 100 is configured to detect if the lid 110 is open or closed. Whether the light is in ON/AUTO mode is controllable from the software application (e.g., mobile app). In ON mode, the light (e.g., a LED lightbar) is always ON when the lid 110 is open, and with the lid 110 is closed, the light is off. In AUTO mode, the light is ON for a limited time (e.g., 15 seconds) and then turned off automatically.

The software application is configured to control whether the temperature reading such as at icon 320 is in Celsius or Fahrenheit. The software application is configured to allow for the password for locking or unlocking box 100 to be changed. The software application is configured to allow the clock icon 320 to be adjusted and/or synchronized with the time provided by the software application.

To use box 100, a user can download a software application and register their box 100 with their user account. The MAC-ID number of the Bluetooth unit of box 100 will be matched with the serial number of box 100, and each will be matched with the user account. Software application is configured to transmit this data to a remote server, for example. This can allow identification of which user is using which box 100. Box 100 is configured in a TURNED OFF state when not yet activated. Heating button 315 is pressed for 5 seconds to TURN ON box 100. Once box 100 is turned on, the Bluetooth will be automatically in PAIR mode for a defined period of time (e.g., 3 minutes).

The user can download the software application, create an account, register the device, and pair the device with box 100. When there is no interaction with the user interface panel 132 for a defined period of time (e.g., 1 minute), the display on icon 320 will be off and there won't be any light, LED indications, etc.

When the customer presses any button, then the display will be turned on. The software's default setting will be that box 100 is in a LOCKED. The default password is 0000, for example. When the user enters the password, the toolbox will be UNLOCKED. The LOCK icon at 330 will be off and the UNLOCK icon at 330 will light on. If the customer enters the wrong password, the light circle 345 (e.g., LED circle) around the temperature setting buttons will blink RED 3 times. When the toolbox is in UNLOCKED state and the user presses lock button 335 button the box will go to LOCK state. In LOCK state, box 100 cannot be opened (e.g., its lid cannot be opened), and when in UNLOCKED state, box 100 is openable (e.g., its lid is openable).

Box 100 is comprised of (a) a storage box made of Acrylonitrile Butadiene Styrene (ABS) plastic; (b) two wheels 142, 152 attached for mobility; (c) a retractable telescoping handle 120; (d) handles 141, 151; (e) a built-in heater 200 on the inside of the storage box 100 to keep items warm; (f) a lock 183 to secure the lid 110 of the box 100 to the main body of the box 100; (g) a lightbar; (h) a user interface panel 132 with a digital LED screen displaying several display icons; (i) a socket 182 and a USB port 184, 185 on the inside the box 100 for charging equipment or utilizing equipment which requires connection to a power source.

According to some embodiments, box 100 is comprised of (a) one 120V AC inlet; (b) two 120V AC outlet; (c) a power supply 5V 5 A; (d) a heater 200; (e) a user interface panel 132 featuring an LED display and keypad 395; (f) a lock 183; (g) a USB-C 184 and a USB-A 185 outlet; and (f) a battery. In some embodiments, the user interface panel 132 has the following display icons, namely, (i) two digits reflecting the set temperature to which the box 100 will heat to; (ii) two digits enclosed in a square showing the actual temperature inside the box 100. The internal temperature will be measured by an internal temperature sensor; (iii) a lock icon and an unlock icon 330, which appear when the box 100 is locked or unlocked, respectively; (iv) a heating icon 340, which appears when the heater 200 is turned on and disappears when the heater 200 is turned off.; (v) a Bluetooth icon 350, which when blinking, signifies the box 100 is ready to be paired with a mobile computer device. When the Bluetooth icon 350 is constantly lit, it signifies the Bluetooth connection between the mobile computer device and the box 100 has been established; (vi) a power icon 360 appears when the box 100 is plugged into an external power source for charging and disappears when the box 100 is unplugged; (vii) a battery icon 370, which depicts four bars when the battery is fully charged, with each bar representing a quarter charge; (viii) a time display 380 showing a clock in real time; (xi) a keypad 395, which may consist of five numerical buttons and a lock button. The numerical buttons are used to input the password to unlock the box 100. The numerical buttons are backlit with white LED light. If the input password is incorrect, then the LED light will flash red three times. The lock button 335 of the keypad 395, when pressed, will lock the box 100. Similar to the numerical buttons, the lock button 335 of the keypad 395 is backlit with white LED light; (x) a rotary knob may also be included, which is used to adjust the temperature setting and access and adjust menu items, and toggle between the main display and menu mode. The rotary knob may be rotated or pressed.

In some embodiments, a software application (e.g., mobile app) is provided and can be used to configure box 100. In some embodiments, the application provides a sliding switch, which, when adjusted to the left (i.e., ON mode), turns the lightbar on, such that the lightbar will remain constantly lit when the lid is open. When the lid is closed, the lightbar will turn off; and when adjusted to the right (i.e. AUTO mode), the lightbar will turn on for 15 seconds, after which, it will turn off automatically.

In some embodiments, box 100 operates as follows: (i) To set up box 100, a user downloads the software application and registers box 100 by creating a user account. The MAC-ID number of the Bluetooth module of the box 100 will serve as the serial number of the box 100 and be linked to the user account; (ii) When using box 100 for the first time, a user holds down the rotary knob for a period of time (e.g., 5 seconds) to turn the box 100 on. Once the box 100 is switched on, the Bluetooth icon will begin to flash for a period of time (e.g., 3 minutes), signaling to the user that the box 100 may now be paired with a mobile computing device; (iii) When there is no interaction with the control panel for a period of time (e.g., 15 seconds or longer), the display will be switched off completely; (iv) When the user pushes any button on the keypad, the display will be turned on, and the buttons on the keypad will be backlit in white. When the user enters the correct password, the box 100 will unlock, causing the lock icon to disappear and the unlock icon to appear. If the user enters the wrong password, the backlit keypad will blink red three times; (v) To set the temperature and turn on the heat, the user will rotate the knob clockwise. Each partial rotation will increase the temperature setting by a defined amount (e.g., 1 degree Celsius (° C.)). To select a particular temperature setting, the user presses the rotary knob to confirm the temperature value and the heater 200 will turn on and heat up the internal temperature of the box 100 to the selected value. The temperature values range from 5° C. to 35° C. in some embodiments (in other embodiments, the permissible temperature range can be another temperature range); (vi) To access the menu from the main display, the user would press and hold the rotary knob for 2 seconds, which in turn, causes the selected menu icon will blink. The selected menu icon consists of access to two menu items, the Bluetooth menu and the clock menu. Rotating the rotary knob will allow a user to toggle between the two menu items. The items in the Bluetooth menu may be selected by pressing the rotary knob. In the clock menu, the hour and minutes may be adjusted by rotating the rotary knob followed by a short press of the rotary knob. After any menu item is adjusted, the control panel display will return to the main display.

Although various embodiments have been described in detail, it should be understood that various changes, substitutions, and alterations can be made herein. Moreover, the scope of the present disclosure is not intended to be limited to the particular embodiments of the process, machine, manufacture, composition of matter, means, methods and steps described in the specification.

As can be understood, the examples described herein and illustrated are intended to be exemplary only.

What is claimed is:

1. A heating box comprising:
a heater configured to heat an interior of the heating box;
a lock configured to lock and unlock a lid of the heating box; and
a user interface configured with heating, connectivity, and locking controls.

2. The heating box of claim 1, further comprising a power supply or battery connected to the heater.

3. The heating box of claim 1, wherein the heating control is configured to configure a temperature of the interior of the heating box using the heater.

4. The heating box of claim 1, wherein the connectivity control is configured to enable pairing with a device using Bluetooth.

5. The heating box of claim 1, wherein the locking control is configured to lock and unlock the lock.

6. A computer-implemented method for configuring a heating box, the method comprising:
pairing a device with the heating box using a software application;
configuring a light of heating box in ON or AUTO mode using the device;
configuring a temperature display of the heating box in Celsius or Fahrenheit using the device;
configuring a password for locking or unlocking the heating box; and
configuring a clock display of the heating box.

7. The heating box of claim 2, wherein the heating control is configured to configure a temperature of the interior of the heating box using the heater.

8. The heating box of claim 2, wherein the connectivity control is configured to enable pairing with a device using Bluetooth.

9. The heating box of claim 8, wherein the connectivity control is configured to enable pairing with a device using Bluetooth.

10. The heating box of claim 2, wherein the locking control is configured to lock and unlock the lock.

11. The heating box of any one of claim 8, wherein the locking control is configured to lock and unlock the lock.
